(19) United States
(12) Patent Application Publication
(10) Pub. No.: US 2019/0246840 A1
(43) Pub. Date: Aug. 15, 2019

(54) HORIZONTAL SHAKING TYPE AUTOMATIC COOKER

(71) Applicants: Jiandan Liu, Beijing (CN); Haiping Yang, Beijing (CN); Xiaoyan Liu, Beijing (CN)

(72) Inventor: Jiandan Liu, Beijing (CN)

(21) Appl. No.: 16/319,402

(22) PCT Filed: Jul. 24, 2017
(86) PCT No.: PCT/CN2017/094001

§ 371 Date: Jan. 21, 2019

(30) Foreign Application Priority Data
Jul. 28, 2016 (CN) 201610599769.9

(51) Int. Cl. A47J 37/10; A47J 36/32; B01F 11/00

(52) U.S. Cl. CPC A47J 37/108; B01F 2215/0026; B01F 11/0031; A47J 36/32

(57) ABSTRACT

A horizontal shaking type automatic cooker includes five parts: a shaking platform, a heating device, a cooking pan, a motor, and an electronic control unit. The shaking platform includes two parts: a fixed base and a shaking flat plate. The fixed base and the shaking flat plate are connected through four eccentric gears that have a same diameter and are in rectangular arrangement. When the four eccentric gears synchronously rotate under the drive of the motor, the shaking flat plate and the cooking pan start to shake horizontally and circumferentially in a non-rotating manner, and a dish in the pan is turned and mixed under the action of inertia and impact force at a pan edge, so as to achieve a stirring effect. When the automatic cooker works during cover opening, water evaporates rapidly, there is much contact with oxygen gas, and a stir-frying effect is desirable.

### CROSS-REFERENCE TO RELATED APPLICATION

This application is a national phase entry of, and claims priority to, International Application No. PCT/CN2017/094001, filed Jul. 24, 2017, which claims the benefit of Chinese Application Number 201610599769.9, filed Jul. 28, 2016. The above-mentioned patent applications are incorporated herein by reference in their entireties.

### TECHNICAL FIELD

The patent for invention belongs to the technical field of household kitchen electrical equipment, and in particular, to a horizontal shaking type automatic cooker.

### BACKGROUND

Conventionally, cooking is usually performed manually in a household. A simple stir-frying action is repeated from day to day in hundreds of millions of households, causing a huge labor waste; and cooking fumes produced during cooking are harmful to health of hundreds of millions of cooking persons. With the development of automation technologies, a variety of automatic cookers have entered people's lives. Among existing automatic cookers, some cookers have complete functions and can complete operations such as feeding, stir-frying, dish removal, and pan cleaning, but have a relatively large size and relatively high costs. Some cookers have a relatively small size but work in a manner of closed cooking, and dishes cooked by these cookers are tasted like those cooked through water boiling, and therefore fragrant and crispy effects of fried dishes cannot be achieved. In terms of a stirring mode, most of the cookers use a form of a stirring rod or roller currently.

Therefore, it would be desirable to provide an automatic cooker that is small in size but allows for stir fry of food products, so as to retain high quality of the food products and reduce the labor needed to perform such cooking operations.

### SUMMARY

The present invention provides a new simple stirring mode for an automatic cooker: horizontally and circumferentially shaking a pan in a non-rotating manner, to drive mixing and turning of a dish in the pan.

A horizontal shaking type automatic cooker in accordance with one embodiment of the invention includes a shaking flat plate and a motor that are disposed on a base, and a heating device and a pan that are disposed on the shaking flat plate; the motor and the heating device each are connected, through a wire, to an electric cabinet disposed on one side of the base; the electric cabinet is internally provided with a PLC; a touch panel on which data can be set is disposed on an upper part of the electric cabinet; the motor controls start, stop, and a rotation speed by using the PLC to control shaking time and a shaking speed; the heating device controls start, stop, and fire power by using the PLC to control heating time and heating temperature; and the pan is placed on the heating device.

In one aspect, the shaking flat plate and the base are connected through four eccentric gears that have a same diameter and that are in rectangular arrangement, lower shafts of the eccentric gears are center shafts and fastened to four bearings of the base, upper shafts of the eccentric gears are eccentric shafts and fastened to four bearings of the shaking flat plate; when the motor drives the gears to rotate, the shaking flat plate and the pan fastened to the shaking flat plate shake horizontally and circumferentially in a non-rotating manner, and a dish in the pan is turned and mixed under the action of inertia and impact at a pan edge, so as to achieve a stirring effect.

In another aspect, the heating device is a non-open-fire cooker such as an induction cooker or an open-fire cooker such as a natural gas stove; when the heating device is a non-open-fire cooker such as an induction cooker, the heating device is placed above the shaking flat plate by using a hob, and the pan is fastened to the heating device by using a pan base; and when the heating device is an open-fire cooker such as a natural gas stove, the heating device may be placed in space between the base and the shaking flat plate, and the pan is directly fastened to the shaking flat plate by using the pan base.

The automatic cooker of the embodiments described herein achieves several technical advantages and beneficial effects.

A new simpler manner is provided for a mechanized “stir-frying” action as main labor in a cooking process.

The automatic cooker can work with a cover opened. When the automatic cooker works during cover opening, it is convenient for water evaporation and full contact between the dishes and air, to achieve fragrant and crispy effects of stir-frying.

Only a conventional oven and pan are made to shake wholly, without changing the conventional oven and pan, and operation habits and a cooking effect of conventional cooking are retained.

### BRIEF DESCRIPTION OF THE DRAWING

Various additional features and advantages of the invention will become more apparent to those of ordinary skill in the art upon review of the following detailed description of one or more illustrative embodiments taken in conjunction with the accompanying drawing. The accompanying drawing, which is incorporated in and constitutes a part of this specification, illustrates one or more embodiments of the invention and, together with the general description given above and the detailed description given below, explain the one or more embodiments of the invention.

FIG. 1 is a schematic structural diagram of a horizontal shaking type automatic cooker in accordance with one embodiment.

### DETAILED DESCRIPTION

The following further describes the present invention with reference to the accompanying drawing and a specific embodiment, but it will be understood that the present invention is not limited to the following embodiment. To make objectives, features, and advantages of the present invention clearer, the following describes an embodiment of the present invention in more detail with reference to accompanying drawing(s) and specific implementations.

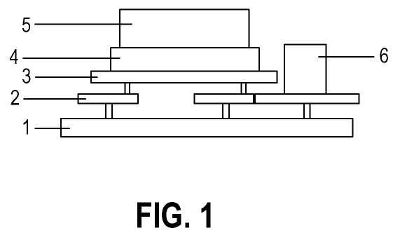

As shown in FIG. 1, a horizontal shaking type automatic cooker in the present invention includes a shaking flat plate (3) and a motor (6) that are disposed on a base (1), and a heating device (4) and a pan (5) that are disposed on the shaking flat plate (3), the motor (6) and the heating device (4) each are connected, through a wire, to an electric cabinet disposed on one side of the base (1); the electric cabinet is internally provided with a PLC; a touch panel on which data can be set is disposed on an upper part of the electric cabinet.

The motor (6) controls start, stop, and a rotation speed by using the PLC to control shaking time and a shaking speed; the heating device (4) controls start, stop, and fire power by using the PLC to control heating time and heating temperature; and the pan (5) is placed on the heating device.

As shown in FIG. 1, the shaking flat plate (3) and the base (1) are connected through four eccentric gears (2) that have a same diameter, lower shafts of the four eccentric gears (2) are center shafts and fastened to four bearings of the base (1), upper shafts of the four eccentric gears (2) are eccentric shafts and fastened to four bearings of the shaking flat plate (3); when the motor (6) drives the gears to rotate, the shaking flat plate (3) and the pan (5) fastened to the shaking flat plate (3) shake horizontally and circumferentially, and a dish in the pan (5) is turned and mixed under the action of inertia and impact at a pan edge, so as to achieve a stirring effect; in a running process, the pan (5) does not rotate and a direction of the pan (5) keeps unchanged.

An operation procedure of the automatic cooker is as follows:

1. After three data parameters, namely, heating power, a shaking speed, and startup duration, are set on the touch panel for different dishes, a heating switch is pressed, the automatic cooker starts heating, and count-down starts to be performed for the startup duration. 2. After a short pause, little edible oil is added; and after a short pause, ingredients, main ingredients, salt, and other seasonings are successively added; and then a shaking switch is pressed. 3. A dish in the pan is uniformly heated during shaking, and after the set startup duration expires, the automatic cooker stops running and completes cooking.

The foregoing is merely a preferred embodiment of the present invention and does not constitute any limitation on the present invention. Any simple modification, alteration, and equivalent structure change made to the foregoing embodiment according to the technical essence of the present invention still fall within the protection scope of the technical solution of the present invention.

The embodiments described above are only descriptions of preferred embodiments of the present invention and are not intended to limit the scope of the present invention. Various variations and modifications can be made to the technical solution of the present invention by those of ordinary skill in the art, without departing from the design and spirit of the present invention. The variations and modifications should all fall within the claimed scope defined by the claims of the present invention.

What is claimed is:

1. A horizontal shaking type automatic cooker, comprising:
an eccentric gear, a shaking flat plate, and a motor that are disposed on a base, and
a heating device and a pan that are disposed on the shaking flat plate,
wherein the shaking flat plate and the base are connected through four eccentric gears that have a same diameter and that are in rectangular arrangement, lower shafts of the four eccentric gears are center shafts and fastened to four bearings of the base, upper shafts of the four eccentric gears are eccentric shafts and fastened to four bearings of the shaking flat plate; when the motor drives the eccentric gears to rotate, the shaking flat plate and the pan fastened to the shaking flat plate shake horizontally and circumferentially, and a dish in the pan is turned and mixed under action of inertia and impact at a pan edge, so as to achieve a stirring effect; and in a running process, the pan does not rotate and a direction of the pan remains unchanged;
the motor and the heating device each is connected, through a wire, to an electric cabinet disposed on one side of the base; the electric cabinet is internally provided with a PLC; a touch panel on which data can be set is disposed on an upper part of the electric cabinet;
the motor controls start, stop, and a rotation speed by using the PLC to control a shaking time and a shaking speed;
the heating device controls start, stop, and fire power by using the PLC to control heating time and heating temperature; and
the pan is placed on the heating device.

2. The automatic cooker according to claim 1, wherein the heating device is defined by one of a non-open-fire cooker and an open-fire cooker;
when the heating device is a non-open-fire cooker, the heating device is placed above the shaking flat plate by using a hob, and the pan is fastened to the heating device by using a pan base; and
when the heating device is an open-fire cooker, the heating device is placed in space that is between the four eccentric gears on the base and that is below the shaking flat plate, and the pan is directly fastened to the shaking flat plate by using the pan base.
